(19) United States
(12) Patent Application Publication
(10) Pub. No.: US 2015/0004859 A1
(43) Pub. Date: Jan. 1, 2015

(54) STAND-UP PADDLE HARNESS

(71) Applicants: Roberto Carlo Enrique Tascheri D'Ausilio, Rio de Janeiro (BR); Carl Andre von Studnitz, Rio de Janeiro (BR); Ricardo Luis Gomes de Carvalho, Rio de Janeiro (BR)

(72) Inventors: Roberto Carlo Enrique Tascheri D'Ausilio, Rio de Janeiro (BR); Carl Andre von Studnitz, Rio de Janeiro (BR); Ricardo Luis Gomes de Carvalho, Rio de Janeiro (BR)

(21) Appl. No.: 14/316,581

(22) Filed: Jun. 26, 2014

(30) Foreign Application Priority Data
Jun. 26, 2013 (BR) BR1020130163937

(51) Int. Cl. B63B 35/85; B60R 22/00

(52) U.S. Cl. CPC B63B 35/85; B60R 22/00
USPC 441/75; 280/801.1

(57) ABSTRACT

The present invention relates to devices and methods that use harnesses and/or support devices with stand-up paddleboards. Specifically, the present disclosure relates to harnesses and/or support devices designed to provide physical support to stand-up paddlers, resulting in improved balance and higher leverage during the paddling process. Because the harnesses and/or support devices can allow stand-up paddlers to achieve greater balance, the physical effort exerted by stand-up paddlers during the paddling process can be reduced. This can result in stand-up paddlers having an increased force to expel upon the paddle during the paddling process. In turn, this eases the process of stand-up paddling, which can improve the overall experience of stand-up paddlers. Furthermore, the harness according to the present invention can result in the stand-up paddler being able to cover a greater distance with the vehicle or board in a shorter amount of time.

### CROSS REFERENCE TO RELATED APPLICATIONS

This application claims the benefit of Brazilian Patent Application No. BR 10 2013 016393 7, to von Studnitz et al., filed on Jun. 26, 2013, and entitled “Stand-Up Paddle Harness.”

### BACKGROUND OF THE INVENTION

1. Field of the Invention

The present invention relates generally to devices and methods for harnesses that provide support and more particularly to innovative devices that use harnesses to provide physical support when using stand-up paddleboards.

2. Description of the Related Art

Stand-up paddle boarding is a paddling sport whereby the paddler stands upright on a vehicle or board, which is similar to a surfboard or a windsurf board. The paddler and the board are propelled along a surface by using a long paddle with a single blade. This surface can be either water, land, or ice, with water presently being the most common use in stand-up paddle boarding.

Presently, stand-up paddlers are not provided with any support, other than the little support provided by the paddle. This means that while paddling, the force opposite to the force exercised upon the paddle can only be counterbalanced by the physical exertion and structure of the stand-up paddler him/herself. As such, this resulting force takes a toll on the posture and physical stamina of the stand-up paddler. Because of this physical exertion, stand-up paddlers have commonly reported accounts of fatigue and pain in the lower back, limbs, and abdominal regions.

FIG. 1 is a side view of traditional stand-up paddle boarding 10. This figure displays how stand-up paddle boarding is done without the use of the present invention. Indeed, the stand-up paddler in FIG. 1 does not utilize a harness or support device. As such, the body of the stand-up paddler must sustain the resulting forces that are transmitted from the paddle. Specifically, the lower back, limbs, and abdominal regions of the stand-up paddler sustain the majority of the force. It becomes evident that with time, fatigue will be inevitable and the stand-up paddler will not be able to apply much power without losing balance.

Based on the forces and resulting physical exertion described above, observers of stand-up paddlers often perceive that the activity is associated with an inadequate or even uncomfortable posture. As a result, many perspective participants of stand-up paddle boarding ultimately choose not to participate in the activity.

A further characteristic of stand-up paddle boarding is the difficulty to achieve and maintain a balancing position upon the vehicle or board, especially when used in water. In some cases, stand-up paddlers can use the paddle itself as a support option. This can result in aiding the balancing process and easing the posture of the paddler. However, during the paddling process, the paddle can no longer be used as a support device. This results in the paddling process actually hindering the balance of the paddler, especially in the case of novice paddlers.

Accordingly, there is a present need for a novel and efficient design for a harness that provides physical support for use with stand-up paddleboards, which specifically deals with the aforementioned problems.

### SUMMARY OF THE INVENTION

Described herein are devices and methods that utilize harnesses and/or support devices for use with stand-up paddleboards. Specifically, the present disclosure relates to harnesses and/or support devices designed to provide physical support to stand-up paddlers. More particularly, the harnesses and/or support devices described in the present disclosure provide an additional support to stand-up paddlers resulting in improved balance and higher leverage during the paddling process.

Because the harnesses and/or support devices described in the present disclosure can allow stand-up paddlers to achieve greater balance, the physical effort exerted by stand-up paddlers during the paddling process can be reduced. This can result in stand-up paddlers having an increased force to expel upon the paddle during the paddling process. In turn, this eases the process of stand-up paddling, which can improve the overall experience of stand-up paddlers. Furthermore, the harness according to the present invention can result in the stand-up paddler being able to cover a greater distance with the vehicle or board in a shorter amount of time.

In one embodiment of the present invention, a harness for a stand-up paddle board comprises: a waist belt for attaching to the waist of a paddler; a waist belt strap connected to said waist belt; a connection strap connected to said waist belt; and a connection cord connected to said connection strap. Additionally, embodiments of the present invention can comprise a waist belt buckle attached to said waist belt, wherein said waist belt buckle is connected to said waist belt strap; a connection strap buckle attached to said waist belt, wherein said connection buckle is connected to said connection strap; a carabiner connected between said connection strap and said connection cord; and a ring connected to said carabiner.

In another embodiment of the present invention, a method for attaching a harness to a stand-up paddle board comprises: attaching a waist belt to the body of a paddler; connecting a waist belt strap to said waist belt; connecting a connection strap to said waist belt; and connecting a connection cord to said connection strap. Furthermore, embodiments of the present invention can comprise attaching a waist belt buckle to said waist belt; connecting said waist belt buckle to said waist belt strap; attaching a connection strap buckle to said waist belt; connecting said connection strap buckle to said connection strap; connecting a carabiner between said connection strap and said connection cord; and connecting a ring between said carabiner and said connection strap.

In yet other embodiments of the present invention, a harness for an individual comprises: a waist belt for attaching to the individual; a waist belt strap connected to said waist belt; and a connection cord connected to said waist belt; wherein said connection cord is adapted for attaching to a remote structure.

These and other aspects and advantages of the invention will become apparent to those skilled in the art from the following detailed description and the accompanying drawings, which illustrate by way of example the features of the invention.

### BRIEF DESCRIPTION OF THE DRAWINGS

FIG. 1 is a side view of traditional stand-up paddle boarding;

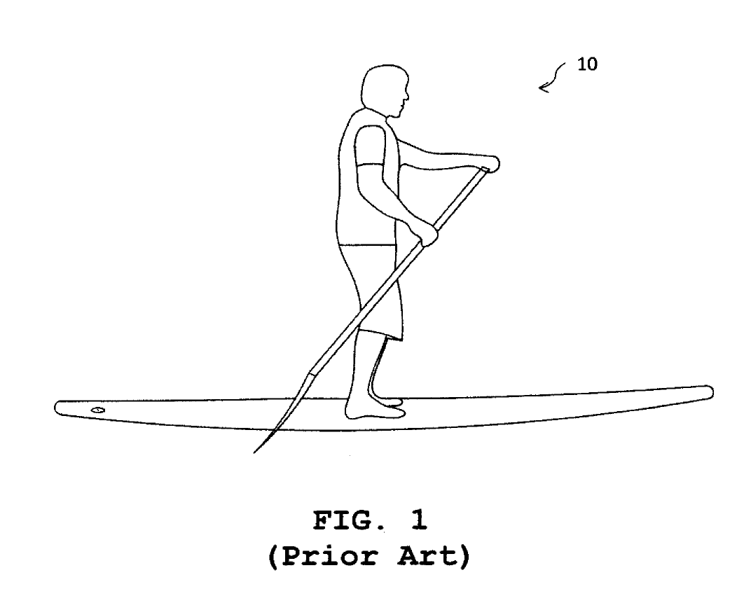

FIG. 2 is a close-up view of one embodiment of a harness 100 incorporating features of the present invention;

FIG. 3 is a side view of a stand-up paddler using harness 100;

FIG. 4 is a close-up view of one embodiment of a harness 200 incorporating features of the present invention;

FIG. 5 is a close-up view of one embodiment of a harness 300 incorporating features of the present invention;

FIG. 6 is a close-up view of a harness 400 incorporating features of the present invention; and

FIG. 7 is a close-up view of one embodiment of a harness 500 incorporating features of the present invention.

### DETAILED DESCRIPTION OF THE INVENTION

The present invention relates to devices and methods that utilize harnesses and/or support devices for use with stand-up paddle boards. For example, the present disclosure relates to harnesses and/or support devices that connect the paddler to the vehicle or board, which are designed to provide support to stand-up paddlers during the paddling process. Furthermore, the harnesses and/or support devices described in the present disclosure provide an additional support to stand-up paddlers that results in improved balance and higher leverage.

The harnesses and/or support devices according to the present disclosure can also allow stand-up paddlers to reduce the physical effort they exert during the paddling process. As a result, stand-up paddlers can reduce the amount of effect they expel in the balancing process, which allows them to have more energy for use in other aspects of paddle boarding, such as increasing the force to expel upon the paddle during the paddling process. Unsurprisingly, this can result in the process of stand-up paddling becoming easier, which can in turn improve the overall experience of stand-up paddlers. Even more so, the harness according to the present disclosure can result in stand-up paddlers becoming more proficient at stand-up paddle boarding, e.g. being able to cover a greater distance with the vehicle or board in a shorter period of time.

The present invention was developed with the objective of easing the activity of stand-up paddle boarding, to generate greater comfort for stand-up paddlers, and to provide stand-up paddlers with a higher proficiency and performance when paddling. As a result, an increase in the autonomy and speed of the vehicle or board can be achieved, which exclusively results from the force output and displacement of the stand-up paddler.

In some embodiments, the harness and/or support device according to the present invention can be presented as an additional support, as, without the present invention, the only contact made by stand-up paddlers with the vehicle or board is through their feet. Therefore, by using the harness and/or support device according to the present invention, stand-up paddlers can also achieve a resting position, which can result in muscle relaxation and breath recovery.

In other embodiments, the harness and/or support device according to the present invention can act as a substitute to a leash, which is a mandatory accessory for stand-up paddle boarding in water. In these embodiments, the harness and/or support device has a dual function, so it is not necessary to use a traditional paddle board leash, which is yet another a practical aspect of the present invention.

Throughout this disclosure, the preferred embodiment and examples illustrated should be considered as exemplars, rather than as limitations on the present invention. As used herein, the term “invention,” “device,” “apparatus,” “method,” “present invention,” “present device,” “present apparatus” or “present method” refers to any one of the embodiments of the invention described herein, and any equivalents. Furthermore, reference to various feature(s) of the “invention,” “device,” “apparatus,” “method,” “present invention,” “present device,” “present apparatus” or “present method” throughout this document does not mean that all claimed embodiments or methods must include the referenced feature(s).

It is also understood that when an element or feature is referred to as being “on” or “adjacent” to another element or feature, it can be directly on or adjacent the other element or feature or intervening elements or features may also be present. In contrast, when an element is referred to as being “directly on” or extending “directly onto” another element, there are no intervening elements present. Additionally, it is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Furthermore, relative terms such as “outer,” “above,” “lower,” “below,” “horizontal,” “vertical” and similar terms may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present invention. As used herein, the term “and/or” includes any and all combinations of one or more of the associated list items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. For example, when the present specification refers to “a” harness, it is understood that this language encompasses a single harness or a plurality or array of harnesses. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

It is understood that the while the present disclosure makes reference to harness for use with paddle boards, and that devices which harness are the primary application concerned with the present invention, devices incorporating features of the present invention can be utilized with any application that has components or elements which aid in harnessing and/or support.

Embodiments of the invention are described herein with reference to different views and illustrations that are schematic illustrations of idealized embodiments of the invention. As such, variations from the shapes of the illustrations as a result, for example, of manufacturing techniques and/or tolerances are expected. Embodiments of the invention should not be construed as limited to the particular shapes of the regions illustrated herein but are to include deviations in shapes that result, for example, from manufacturing.

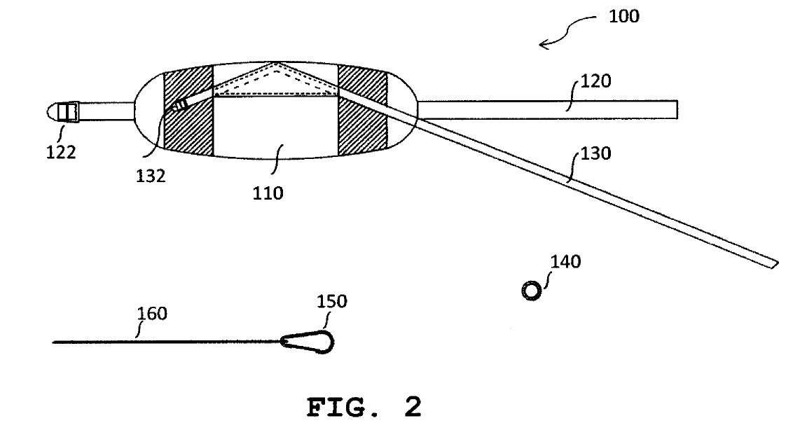

FIG. 2 is a close-up view of one embodiment of a harness 100 incorporating features of the present invention. Harness 100 comprises waist belt 110, waist belt strap 120, waist belt buckle 122, connection strap 130, connection strap buckle 132, ring 140, carabiner 150, and connection cord 160. Waist belt 110 and waist belt strap 120 can both be made of any non-perishable material, such as polyester. Connection strap 130 can also be made of any non-perishable material, such as polyester. Waist belt buckle 122 and connection strap buckle 132 can be made of any plastic or plastic-like material. Ring 140 can be made of any metallic material, such as stainless steel, or any plastic or plastic-like material. Carabiner 150 can also be made of any metallic material, such as stainless steel, or any plastic or plastic-like material. Connection cord 160 can be made of any non-perishable material, such as polyester.

In one embodiment according to the present invention, harness 100 can be attached to a stand-up paddler and to a vehicle or board, in order to provide the stand-up paddler with physical support while paddling. The stand-up paddler can attach the harness 100 by placing the waist belt 110 over his/her waist, and then connecting the waist belt strap 120 through the waist belt buckle 122 in order to secure the waist belt 110 to his/her waist. Additionally, connection strap 130 can be connected through connection strap buckle 132, which is likewise secured to waist belt 110. Connection strap 130 and/or waist belt strap 120 can have a few inches of slack for adjustment purposes.

As such, waist belt buckle 122 can be attached to waist belt 110, and also connected to waist belt strap 120. Furthermore, connection strap buckle 132 can be attached to waist belt 110, as well as connected to connection strap 130.

Carabiner 150 can be connected between connection strap 130 and connection cord 160. Moreover, ring 140 can be connected to carabiner 150. Ring 140 can also be connected between carabiner 150 and connection strap 130. Likewise, carabiner 150 can be connected between ring 140 and connection cord 160.

Connection cord 160 can be connected to a vehicle or board, such as a stand-up paddle board. Furthermore, connection cord 160 can be connected between carabiner 150 and the vehicle or board. Because of this, the stand-up paddler can be secured to the vehicle or board. By attaching connection cord 160 in this manner, the stand-up paddler can be secured to the vehicle or board. It should be noted that most vehicles or boards that are used in water are equipped with attach points to which a cord, such as connection cord 160, can be connected.

In the harness according to the present invention, adjustments can be made to the length of several cords, in order to secure the paddler to the vehicle or board. For instance, the length of waist belt strap 120, connection strap 130, and/or connection cord 160 can be adjusted, as well as any other adjustable straps or cords that are associated with the present invention.

In addition to any of the straps or cords, the stand-up paddler can adjust any of the buckles according to the present invention, such as waist belt buckle 122 and/or connection strap buckle 132. Moreover, the stand-up paddler can disconnect any of the other components, such as the carabiner 150 and or ring 140, in order to make any adjustments. These adjustments can be made when the stand-up paddler is not paddling, while the stand-up paddler is paddling, or at any other time.

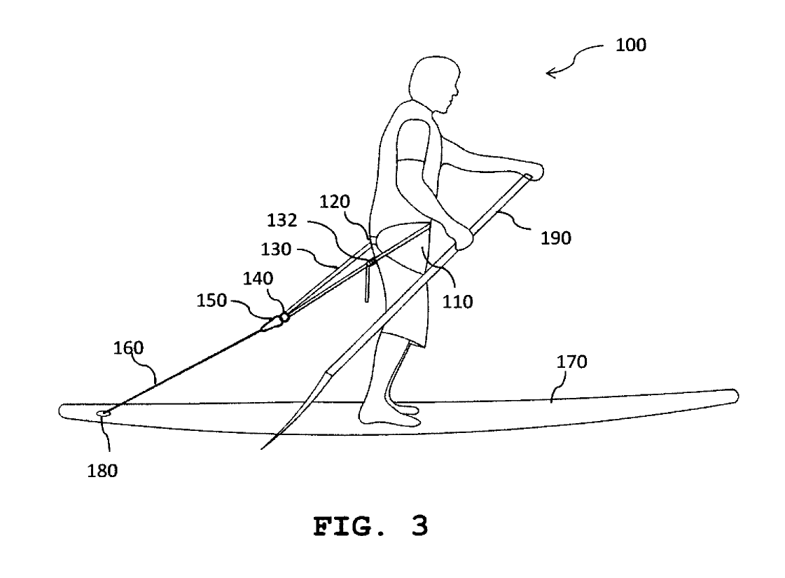

FIG. 3 illustrates a side view of a stand-up paddler using harness 100 according to the present invention. In addition to the components of harness 100 described above, FIG. 3 displays vehicle or board 170, attach point 180, and paddle 190. As described above, in some embodiments, the force transmitted from paddle 190 is counteracted by harness 100. Furthermore, the stand-up paddler can assume stance by tilting forward, which can yield a more comfortable position for the stand-up paddler. Therefore, the harness according to the present invention promotes comfort, helps stand-up paddlers achieve and maintain better balance, and helps increase the paddling force or power of stand-up paddlers.

In some embodiments according to the present invention, the stand-up paddler can stand on the center of the vehicle or board. In other embodiments according to the present invention, the stand-up paddler can stand in front of the center of the vehicle or board. In yet other embodiments according to the present invention, the stand-up paddler can stand behind the center of the vehicle or board.

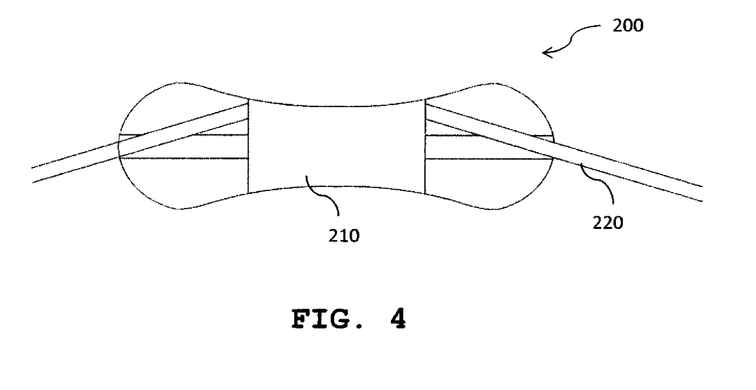

FIG. 4 is a close-up view of another embodiment of harness 200 incorporating features of the present invention. Harness 200 comprises waist belt 210 and waist belt strap 220.

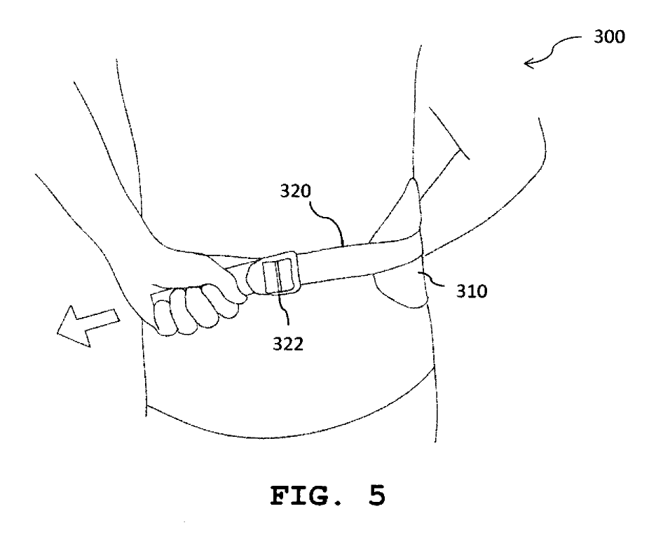

FIG. 5 is a close-up view of another embodiment of harness 300 incorporating features of the present invention. Harness 300 comprises waist belt 310, waist belt strap 320, and waist belt buckle 322. FIG. 5 displays how a stand-up paddler can adjust the harness 300 once it is attached to their body. Specifically, a stand-up paddler can adjust the waist belt strap 320, in order to best fit harness 300 to their respective body.

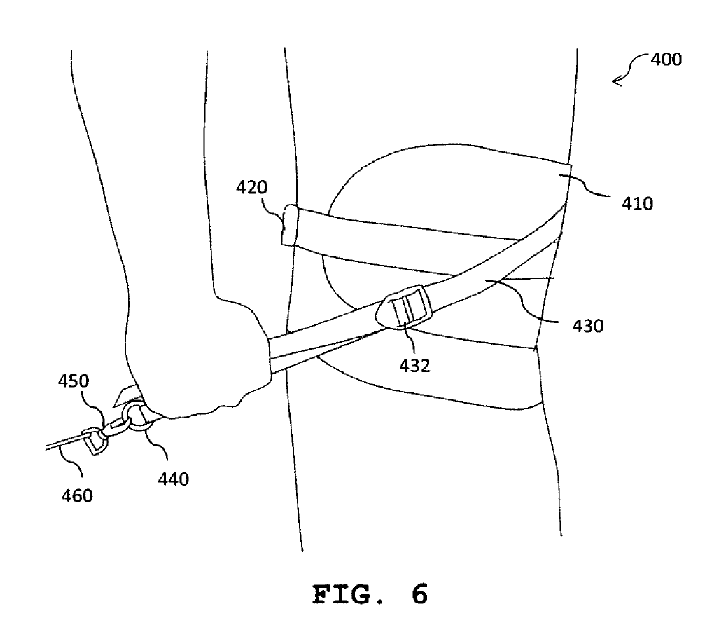

FIG. 6 is a close-up view of another embodiment of harness 400 incorporating features of the present invention. Harness 400 comprises waist belt 410, waist belt strap 420, connection strap 430, connection strap buckle 432, ring 440, carabiner 450, and connection cord 460. FIG. 6 also illustrates how a stand-up paddler can adjust the harness 300 once it is attached to their body. More particularly, stand-up paddler can adjust connection strap 430, in order to best fit harness 400 to their respective body.

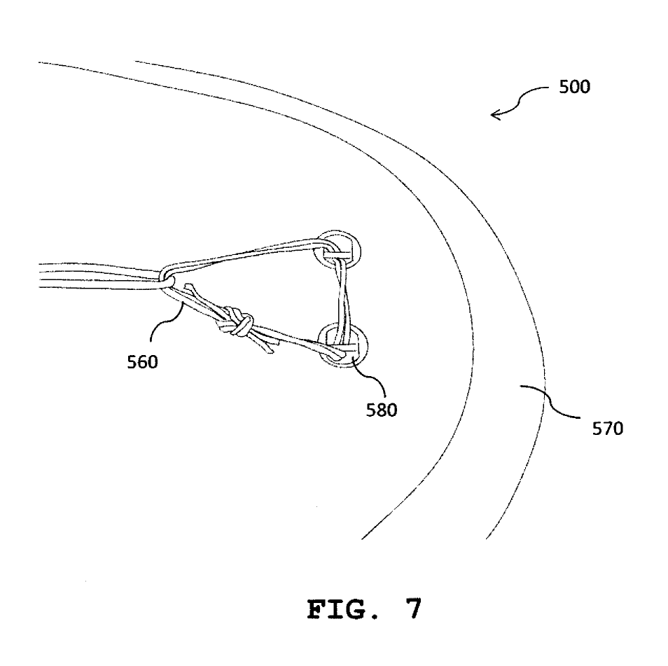

FIG. 7 is a close-up view of another embodiment of harness 500 incorporating features of the present invention. Harness 500 comprises connection cord 560, vehicle or board 570, and attach points 580. FIG. 7 displays how connection cord 560 can be connected to attach points 580, which are part of vehicle or board 570.

It is understood that embodiments presented herein are meant to be exemplary. Embodiments of the present invention can comprise any combination of compatible features shown in the various figures, and these embodiments should not be limited to those expressly illustrated and discussed.

Although the present invention has been described in detail with reference to certain configurations thereof, other versions are possible. Therefore, the spirit and scope of the invention should not be limited to the versions described above.

The foregoing is intended to cover all modifications and alternative constructions falling within the spirit and scope of the invention as expressed in the appended claims, wherein no portion of the disclosure is intended, expressly or implicitly, to be dedicated to the public domain if not set forth in the claims.

1. A harness for an individual, comprising:
a waist belt for attaching to the individual;
a waist belt strap connected to said waist belt;
a connection strap connected to said waist belt; and
a connection cord connected to said connection strap.

2. The harness of claim 1, further comprising a waist belt buckle attached to said waist belt.

3. The harness of claim 2, wherein said waist belt buckle is connected to said waist belt strap.

4. The harness of claim 1, further comprising a connection strap buckle attached to said waist belt.

5. The harness of claim 4, wherein said connection buckle is connected to said connection strap.

6. The harness of claim 1, further comprising a carabiner connected to said connection cord.

7. The harness of claim 6, further comprising a ring connected to said carabiner.

8. The harness of claim 7, wherein said ring is connected between said carabiner and said connection strap.

9. The harness of claim 7, wherein said carabiner is connected between said ring and said connection cord.

10. The harness of claim 1, wherein said connection cord is connected to a remote vehicle.

11. The harness of claim 10, wherein the individual is secured to said remote vehicle.

12. The harness of claim 6, wherein said connection cord is connected between said carabiner and a remote vehicle.

13. A method for attaching a harness to an individual, comprising:
attaching a waist belt to the individual;
connecting a waist belt strap to said waist belt;
connecting a connection strap to said waist belt; and
connecting a connection cord to said connection strap.

14. The method of claim 13, further comprising:
attaching a waist belt buckle to said waist belt; and
connecting said waist belt buckle to said waist belt strap.

15. The method of claim 13, further comprising:
attaching a connection strap buckle to said waist belt; and
connecting said connection strap buckle to said connection strap.

16. The method of claim 13, further comprising:
connecting a carabiner to said connection cord.

17. The method of claim 16, further comprising:
connecting a ring to said carabiner.

18. The method of claim 13, further comprising:
connecting said connection cord to a remote vehicle.

19. The method of claim 18, wherein the individual is secured to said remote vehicle.

20. A harness for an individual, comprising:
a waist belt for attaching to the individual;
a waist belt strap connected to said waist belt; and
a connection cord connected to said waist belt;
wherein said connection cord is adapted for attaching to a remote structure.
